(19) United States
(12) Patent Application Publication
(10) Pub. No.: US 2007/0279807 A1
(43) Pub. Date: Dec. 6, 2007

(54) Carriage assembly and storage medium drive

(75) Inventors: Hiroaki Kobayashi, Kawasaki (JP); Kouichi Tokairin, Kawasaki (JP); Hirofumi Suzuki, Kawasaki (JP); Hideki Yamaguchi, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/521,779

(22) Filed: Sep. 15, 2006

(30) Foreign Application Priority Data
May 30, 2006 (JP) 2006-149155

(51) Int. Cl. G11B 5/55

(52) U.S. Cl. 360/264.2

(57) ABSTRACT

A first flexible printed wiring board is attached to the supported end of a carriage. First terminals are exposed on the first flexible printed wiring board. A second flexible printed wiring board extending from a head slider toward the supported end of the carriage. The second flexible printed wiring board is overlaid on the first flexible printed wiring board. Second terminals are exposed on the second flexible printed wiring board. The second terminals are bonded to the first terminals. A step defines a wall surface facing the edge of the second flexible printed wiring board on the first flexible printed wiring board. A depression is defined on the first flexible printed wiring board. The second flexible printed wiring board is received in the depression, the second terminal can accurately be positioned on the first terminal in a facilitated manner.

### BACKGROUND OF THE INVENTION

1. Field of the Invention

The present invention relates to a storage medium drive including a first flexible printed wiring board attached to the supported end of a carriage and a second flexible printed wiring board extending from the tip end of the carriage toward the supported end of the carriage for connection to the first flexible printed wiring board.

2. Description of the Prior Art

A head suspension assembly having the structure of a so-called long-tail includes a first flexible printed wiring board extending backward from a head suspension as disclosed in Japanese Patent Application Publication No. 11-120715. When the head suspension assembly is attached to the tip end of a carriage arm, the tip end of the first flexible printed wiring board is connected to a second flexible printed wiring board attached to the side surface of a carriage. First terminals on the first flexible printed wiring board are positioned on the corresponding second terminals on the second flexible printed wiring board, respectively. The first flexible printed wiring board is utilized to supply a head slider with a sensing current and a writing current.

The tip end of the first flexible printed wiring board is first roughly positioned on the second flexible printed wiring board when the first flexible printed wiring board is coupled to the second flexible printed wiring board. An operator manipulates the first flexible printed wiring board for a fine adjustment so as to precisely position the first terminals on the first flexible printed wiring board on the corresponding second terminals on the second flexible printed wiring board. The operator is required to check the positions of the first terminals and the second terminals with his eyes. It is troublesome to complete the connection between the first and second flexible printed wiring boards.

### SUMMARY OF THE INVENTION

It is accordingly an object of the present invention to provide a carriage assembly and a storage medium drive, contributing to a fine alignment of a first terminal on a second terminal in a facilitated manner.

According to a first aspect of the present invention, there is provided a carriage assembly comprising: a carriage; a head slider attached to the tip end of the carriage; a first flexible printed wiring board attached to the supported end of the carriage; a first terminal exposed on the first flexible printed wiring board; a second flexible printed wiring board extending from the head slider toward the supported end of the carriage, the second flexible printed wiring board overlaid on the first flexible printed wiring board; a second terminal exposed on the second flexible printed wiring board, the second terminal bonded to the first terminal; and a step defining a wall surface facing the edge of the second flexible printed wiring board on the first flexible printed wiring board.

A step is formed on the first flexible printed wiring board in the carriage assembly. The step defines the wall surface facing the edge of the second flexible printed wiring board. A depression is thus defined on the first flexible printed wiring board, for example. The second flexible printed wiring board is overlaid on the first flexible printed wiring board when the first and second terminals are bonded to each other. In this case, when the second flexible printed wiring board is received in the depression, the second terminal can accurately be positioned on the first terminal in a facilitated manner. Furthermore, an operator is allowed to simply check with his eyes whether or not the second terminal is received in the depression, when he is required to check whether or not the second terminal is positioned right at the first terminal. The operator is not required to check the relative position between the first and second terminals with his eyes. This results in a significant reduction in the period of positioning the second terminal relative to the first terminal.

The step may be defined based on a film material attached to the surface of the first flexible printed wiring board. The film material contributes to an easier establishment of the step. The first flexible printed wiring board is not subjected to any change of design. Alternatively, the step may be defined based on a depression formed in the surface of the first flexible printed wiring board. The thickness of the first flexible printed wiring board may partially be changed so as to define the depression.

The height of the step may be set larger than the thickness of the second flexible printed wiring board in the carriage assembly. The second flexible printed wiring board can thus reliably be fitted in the depression inside the step. Once the second flexible printed wiring board is fitted in the depression, the second flexible printed wiring board can be held in the depression. The second flexible printed wiring board is kept in the depression when the second terminal is soldered to the first terminal. Working process can be simplified.

The carriage assembly may be incorporated in a storage medium drive. In this case, the storage medium drive may comprise: a storage medium; a carriage swinging around a support shaft; a head slider attached to the tip end of the carriage, the head slider opposed to the storage medium; a first flexible printed wiring board attached to the supported end of the carriage; a first terminal exposed on the first flexible printed wiring board; a second flexible printed wiring board extending from the head slider toward the supported end of the carriage, the second flexible printed wiring board overlaid on the first flexible printed wiring board; a second terminal exposed on the second flexible printed wiring board, the second terminal bonded to the first terminal; and a step defining a wall surface facing the edge of the second flexible printed wiring board on the first flexible printed wiring board.

According to a second aspect of the present invention, there is provided a carriage assembly comprising: a carriage; a head slider attached to the tip end of the carriage; a first flexible printed wiring board attached to the supported end of the carriage; a first terminal exposed on the first flexible printed wiring board; a second flexible printed wiring board extending from the head slider toward the supported end of the carriage, the second flexible printed wiring board overlaid on the first flexible printed wiring board; a second terminal exposed on the second flexible printed wiring board, the second terminal bonded to the first terminal; and a step defining a wall surface facing first and second edges of the second flexible printed wiring board on the first flexible printed wiring board, the first edge extending along a first imaginary reference line, the second edge extending along a second imaginary reference line intersecting with the first imaginary reference line.

The carriage assembly allows the wall surface to face the first and second edges of the second flexible printed wiring board. The step may be formed to extend at a position adjacent to part of the second flexible printed wiring board. When the first and second edges of the second flexible printed wiring board collide against the wall surface, for example, the second terminal can accurately be positioned on the first terminal in a facilitated manner. Furthermore, an operator is allowed to simply check with his eyes whether or not the second terminal is arranged along the wall surface, when he is required to check whether or not the second terminal is positioned right at the first terminal. The operator is not required to check the relative position between the first and second terminals with his eyes. This results in a significant reduction in the period of positioning the second terminal relative to the first terminal.

The step may be defined based on a film material attached to the surface of the first flexible printed wiring board in the carriage assembly in the same manner as described above. Alternatively, the step may be defined based on a depression formed in the surface of the first flexible printed wiring board. The height of the step may be set larger than the thickness of the second flexible printed wiring board.

The carriage assembly may be incorporated in a storage medium drive. The storage medium drive may comprise: a recording disk; a carriage swinging around a support shaft; a head slider attached to the tip end of the carriage; a first flexible printed wiring board attached to the supported end of the carriage; a first terminal exposed on the first flexible printed wiring board; a second flexible printed wiring board extending from the head slider toward the supported end of the carriage, the second flexible printed wiring board overlaid on the first flexible printed wiring board; a second terminal exposed on the second flexible printed wiring board, the second terminal bonded to the first terminal; and a step defining a wall surface facing first and second edges of the second flexible printed wiring board on the first flexible printed wiring board, the first edge extending along a first imaginary reference line, the second edge extending along a second imaginary reference line intersecting with the first imaginary reference line.

A specific flexible printed wiring board is utilized to realize the carriage assembly and the storage medium drive. The flexible printed wiring board may comprise: a sheet metal; an insulating layer formed on the sheet metal; an electrically-conductive layer formed on the insulating layer; a protecting layer covering over the insulating layer at a position adjacent to the electrically-conductive layer, the protecting layer having an opening allowing part of the electrically-conductive layer to be exposed; and a step formed at a position outside the opening to surround at least part of the electrically-conductive layer exposed within the opening. The flexible printed wiring board can be utilized to realize the aforementioned carriage assemblies. It should be noted that the step may be defined based on a film material attached to the surface of the protecting layer. Alternatively, the step may be defined based on a depression formed in the surface of the protecting layer.

According to a third aspect of the present invention, there is provided a method of positioning a terminal, comprising attaching a first flexible printed wiring board on a second flexible printed wiring board, wherein the method comprising arranging the edge of the first flexible printed wiring board along a step defining a wall surface facing the edge of the first flexible printed wiring board on the second flexible printed wiring board, so as to position a first terminal of the first flexible printed wiring board on a second terminal of the second flexible printed wiring board.

The step is formed on the second flexible printed wiring board. The step defines a wall surface facing the edge of the first flexible printed wiring board. The first flexible printed wiring board is overlaid on the second flexible printed wiring board when the first and second terminals are bonded to each other. When the first flexible printed wiring board is positioned along the wall surface, the first terminal can accurately be aligned with the second terminal in a facilitated manner. This results in a significant reduction in the period of positioning the first terminal relative to the second terminal.

The step may be defined based on a film material attached to the surface of the second flexible printed wiring board in the same manner as described above. Alternatively, the step may be defined based on a depression formed in the surface of the second flexible printed wiring board. The height of the step may be set larger than the thickness of the first flexible printed wiring board.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a plan view schematically illustrating the inner structure of a hard disk drive (HDD) as an example of a storage medium drive according to an embodiment of the present invention;

FIG. 2 is a perspective view schematically illustrating a carriage assembly;

FIG. 3 is an enlarged partial side view schematically illustrating first and second flexible printed wiring boards;

FIG. 4 is a sectional view taken along the line 4-4 in FIG. 3;

FIG. 5 is an enlarged partial perspective view schematically illustrating the second flexible printed wiring board positioned on the first flexible printed wiring board;

FIG. 6 is an enlarged partial side view schematically illustrating first and second flexible printed wiring boards according to another embodiment of the present invention; and

FIG. 7 is an enlarged partial side view, corresponding to FIG. 4, schematically illustrating the first and second flexible printed wiring boards according to another embodiment of the present invention.

### DESCRIPTION OF THE PREFERRED EMBODIMENT

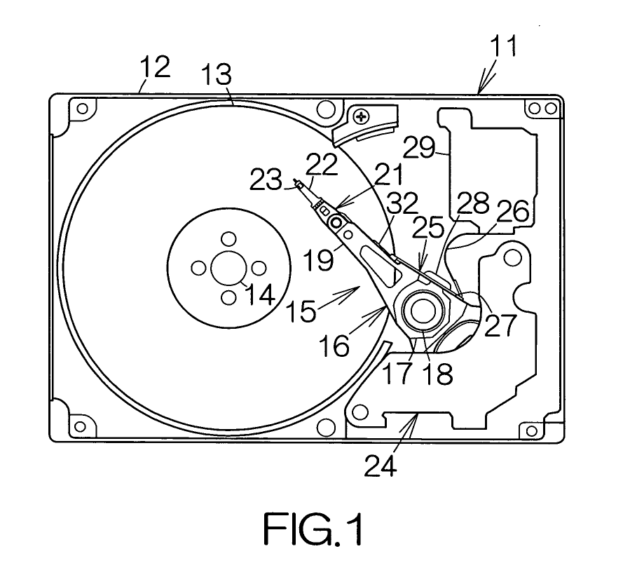

FIG. 1 schematically illustrates the inner structure of a hard disk drive, HDD, 11 as an example of a storage medium drive or storage device according to the present invention. The hard disk drive 11 includes a box-shaped enclosure base 12 defining an inner space of a flat parallelepiped, for example. The enclosure base 12 may be made of a metallic material such as aluminum, for example. Molding process may be employed to form the enclosure base 12. An enclosure cover, not shown, is coupled to the enclosure base 12. The enclosure cover closes the opening of the enclosure base 12. Pressing process may be employed to form the enclosure cover out of a plate material, for example.

At least one magnetic recording disk 13 as a storage medium is enclosed in the inner space of the enclosure base 12. The magnetic recording disk or disks 13 are mounted on the driving shaft of a spindle motor 14. The spindle motor 14 drives the magnetic recording disk or disks 13 at a higher revolution speed such as 5,400 rpm, 7,200 rpm, 10,000 rpm, 15,000 rmp, or the like.

A carriage assembly 15 is also enclosed in the inner space of the enclosure base 12. The carriage assembly 15 includes a carriage 16. The carriage 16 includes a carriage block 17. The carriage block 17 is supported on a vertical support shaft 18 for relative rotation. Carriage arms 19 are defined in the carriage block 17. The carriage arms 19 are designed to extend in a horizontal direction from the vertical support shaft 18. The carriage block 17 may be made of aluminum, for example. Extrusion process may be employed to form the carriage block 17, for example.

A head suspension assembly 21 is attached to the front or tip end of the individual carriage arm 19. The head suspension assembly 21 is designed to extend forward from the carriage arm 19. The head suspension assembly 21 includes a head suspension 22. The head suspension 22 is designed to extend forward from the tip end of the carriage arm 19. A predetermined urging force is applied to the front or tip end of the head suspension 22 toward the surface of the corresponding magnetic recording disk 13. A flying head slider 23 is fixed to the tip end of the head suspension 22.

An electromagnetic transducer, not shown, is mounted on the flying head slider 23. The electromagnetic transducer includes a write element and a read element. The write element may include a thin film magnetic head designed to write magnetic bit data onto the magnetic recording disk 13 by utilizing a magnetic field induced at a thin film coil pattern. The read element may include a giant magnetoresistive (GMR) element or a tunnel-junction magnetoresistive (TMR) element designed to discriminate magnetic bit data on the magnetic recording disk 13 by utilizing variation in the electric resistance of a spin valve film or a tunnel-junction film, for example. Here, a heater, not shown, is incorporated in the flying head slider 23 at a position adjacent to the electromagnetic transducer. As conventionally known, the heater serves to generate heat for controlling the flying height of the flying head slider 23.

When the magnetic recording disk 13 rotates, the flying head slider 23 is allowed to receive an airflow generated along the rotating magnetic recording disk 13. The airflow serves to generate a positive pressure or a lift as well as a negative pressure on the flying head slider 23. The flying head slider 23 is thus allowed to keep flying above the surface of the magnetic recording disk 13 during the rotation of the magnetic recording disk 13 at a higher stability established by the balance between the urging force of the head suspension 22 and the combination of the lift and the negative pressure.

A power source or voice coil motor, VCM, 24 is coupled to the carriage block 17. The voice coil motor 24 serves to drive the carriage block 17 around the vertical support shaft 18. The rotation of the carriage block 17 allows the carriage arms 19 and the head suspension assemblies 21 to swing. When the carriage arm 19 swings around the vertical support shaft 18 during the flight of the flying head slider 23, the flying head slider 23 is allowed to move along the radial direction of the magnetic recording disk 13. The electromagnetic transducer on the flying head slider 23 can thus be positioned right above a target recording track on the magnetic recording disk 13.

A flexible printed circuit board unit 25 is located on the supported end of the carriage 16, namely the carriage block 17. The flexible printed circuit board unit 25 includes a first flexible printed wiring board 26. An adhesive may be utilized to attach the first flexible printed wiring board 26 to the surface of a metal plate 27 such as a stainless steel plate, for example. A screw may be utilized to fix the metal plate 27 to the carriage block 17, for example.

A head IC (integrated circuit) or preamplifier IC 28 is mounted on the first flexible printed wiring board 26. The preamplifier IC 28 is designed to supply the read element with a sensing current when the magnetic bit data is to be read. The preamplifier IC 28 is also designed to supply the write element with a writing current when the magnetic bit data is to be written. Likewise, the preamplifier IC 28 is designed to supply the heater with a controlling current for the heater. A small-sized circuit board 29 is located within the inner space of the enclosure base 12. The small-sized circuit board 29 is designed to supply the preamplifier IC 28 with the sensing current, the writing current and the controlling current. The small-sized circuit board 29 is designed to supply the preamplifier IC 28 with the sensing current, the writing current and the controlling current. A second flexible printed wiring board 32 is utilized to supply the sensing current, the writing current and the controlling current from the preamplifier IC 28 to the flying head slider 23. The second flexible printed wiring boards 32 are individually related to the corresponding head suspensions 22.

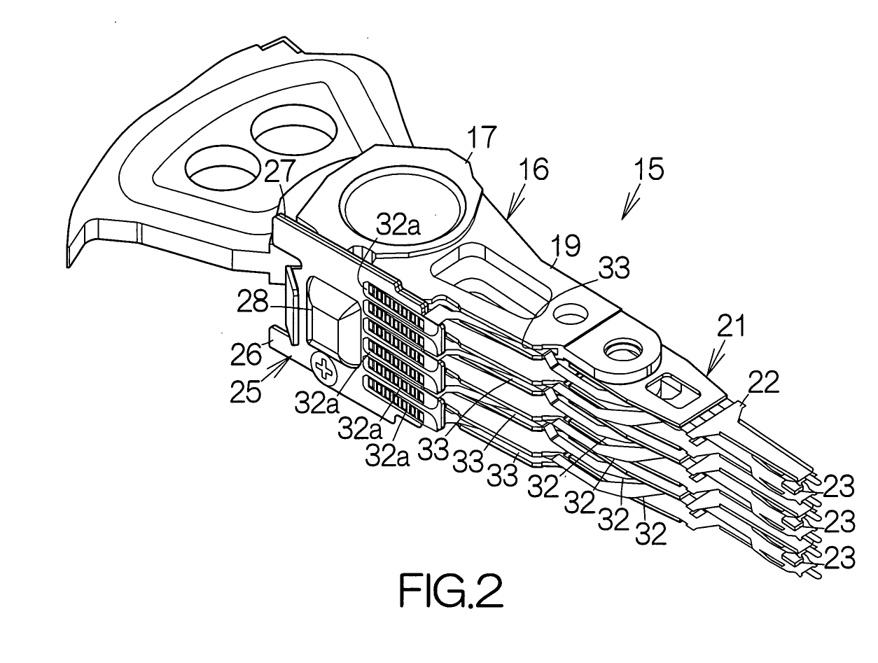

As shown in FIG. 2, one end or front end of the second flexible printed wiring board 32 is fixed to the head suspension 22. A wiring pattern on the second flexible printed wiring board 32 is connected to the flying head slider 23. An adhesive may be utilized to fix the second flexible printed wiring board 32 to the head suspension 22, for example. The second flexible printed wiring board 32 is designed to extend backward from the head suspension 22 along the side surface of the carriage arm 19. The head suspension assembly 21 has the structure of a so-called long-tail. The carriage arm 19 includes a groove 33. The second flexible printed wiring board 32 is received in the groove 33. The groove 33 is defined in the side surface of the carriage arm 19.

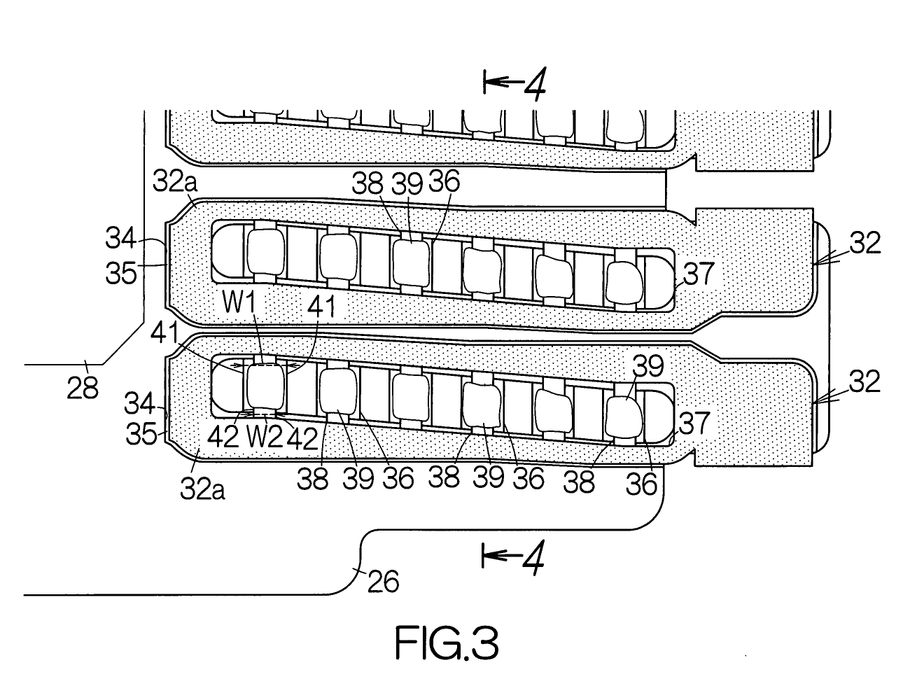

The other end or rear end of the second flexible printed wiring board 32 is overlaid on the first flexible printed wiring board 26 located on the carriage block 17. An elongated tail end piece 32a is defined at the other end of the second flexible printed wiring board 32. The tail end piece 32a is designed to extend along the surface of the first flexible printed wiring board 26. As shown in FIG. 3, a step 34 is formed on the first flexible printed wiring board 26 at a position adjacent to the individual tail end piece 32a. The individual step 34 serves to define a depression 35 on the first flexible printed wiring board 26. The depression 35 is contoured to correspond to the contour of the tail end piece 32a. The tail end pieces 32a are thus received in the depressions 35, respectively.

First terminals 36, six of those, for example, are exposed on the bottom surface of the individual depression 35. The first terminals 36 are surrounded by the step 34. The first terminals 36 are arranged in a line at predetermined intervals. The first terminals 36 are made of an electrically-conductive material such as copper. The first terminals 36 are connected to a wiring pattern, not shown, on the first flexible printed wiring board 26. The wiring pattern is connected to the preamplifier IC 28, for example.

An opening 37 is defined in the individual tail end piece 32a. The opening 37 is designed to extend in the longitudinal direction of the tail end piece 32a. Second terminals 38, six of those, for example, are exposed in the opening 37. The second terminals 38 are arranged in the longitudinal direction at predetermined intervals. The second terminals 38 are made of an electrically-conductive material such as copper. Gold and nickel layers may be plated on the surface of the copper, for example. The second terminals 38 are connected to the wiring pattern, not shown, on the second flexible printed wiring board 32. The individual second terminal 38 establishes a so-called flying lead.

The second terminals 38 are located on the corresponding first terminals 36, respectively. Solders 39 serve to bond the second terminals 38 to the first terminals 38. The solders 39 may be located between the first and second terminals 36, 38 as well as on the first terminals 36. The solders 39 serve to establish an electrical connection between the first and second terminals 36, 38, so that an electrical connection is established between the flying head slider 23 and the small-sized circuit board 29. A pair of parallel contours 41 determines the width W2 of the individual first terminal 36. A pair of parallel contours 42 likewise determines the width W2 of the individual second terminal 38. The width W1 of the first terminal 36 is set larger than the width W2 of the second terminal 38.

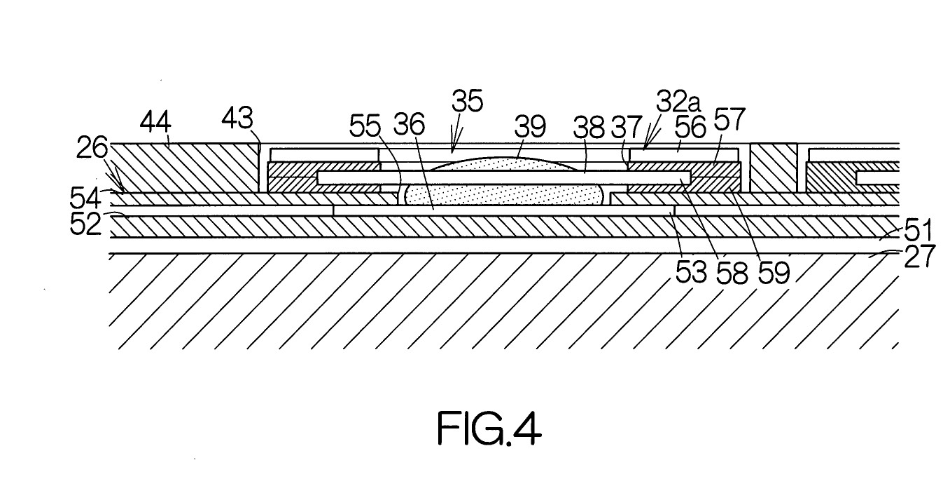

As shown in FIG. 4, the individual step 34 defines a wall surface 43. The wall surface 43 faces the edge of the tail end piece 32a. Here, the term “face” in this specification includes the meaning that the edge of the tail end piece 32a contacts with the wall surface 43. The wall surface 43 is defined in the edge of a film material 44. The film material 44 may be adhered to the entire surface of the first flexible printed wiring board 26 on the metal plate 27. Alternatively, the film material 44 may be adhered to part of the surface of the first flexible printed wiring board 26 at a position adjacent to the tail end piece 32a. The film material 44 may be made of a resin material such as polyimide resin, for example.

The height of the step 34 from the surface of the first flexible printed wiring board 26, namely the depth of the depression 35, is set larger than the thickness of the tail end piece 32a of the second flexible printed wiring board 32. The tail end piece 32a is thus completely received in the depression 35 when the tail end piece 32a is set on the surface of the first flexible printed wiring board 26. Here, the wall surface 43 may stand in the vertical direction perpendicular to the surface of the first flexible printed wiring board 26. It should be noted that the wall surface 43 may get remoter from the edge of the tail end piece 32a at a position remoter from the surface of the first flexible printed wiring board 26.

The first flexible printed wiring board 26 includes a sheet metal 51 such as a stainless steel plate. An insulating layer 52, an electrically-conductive layer 53 and a protecting layer 54 are overlaid on the sheet metal 51 in this sequence. The first flexible printed wiring board 26 allows the sheet metal 51 to be received on the metal plate 27. The protecting layer 54 covers over the insulating layer 52 at a position outside the electrically-conductive layer 53. The electrically-conductive layer 53 forms the wiring pattern extending on the first flexible printed wiring board 26. The electrically-conductive layer 53 is exposed in an opening 55 formed in the protecting layer 54. The electrically-conductive layer 53 in this manner forms the aforementioned first terminals 36. The insulating layer 52 and the protecting layer 54 may be made of a resin material such as polyimide resin, for example.

The individual second flexible printed wiring board 32 likewise includes a sheet metal 56 such as a stainless steel plate. An insulating layer 57, an electrically-conductive layer 58 and a protecting layer 59 are overlaid on the sheet metal 56 in this sequence. The second flexible printed wiring board 32 allows the protecting layer 59 to be received on the surface of the first flexible printed wiring board 26. The electrically-conductive layer 58 forms the wiring pattern extending on the second flexible printed wiring board 32. The aforementioned opening 37 is formed in the sheet metal 56, the insulating layer 57 and the protecting layer 59. The electrically-conductive layer 58 forms the aforementioned second terminals 38 in the opening 37. The insulating layer 57 and the protecting layer 59 may be made of a resin material such as polyimide resin, for example.

Next, a detailed description will be made on a method of bonding the second terminals to the first terminals. The metal plate 27 and the first flexible printed wiring board 26 are attached to the carriage block 17. The film material 44 is previously attached to the first flexible printed wiring board 26. The solders 39 are applied to the upper surfaces of the first terminals 36 in the depression 35. Solder cream may be employed as the solders 39. The melting point of the solders 39 is set in a range between 220 degrees Celsius and 240 degrees Celsius, for example. The solders 39 on the adjacent ones of the first terminals 36, 36 are distanced from each other at a predetermined interval.

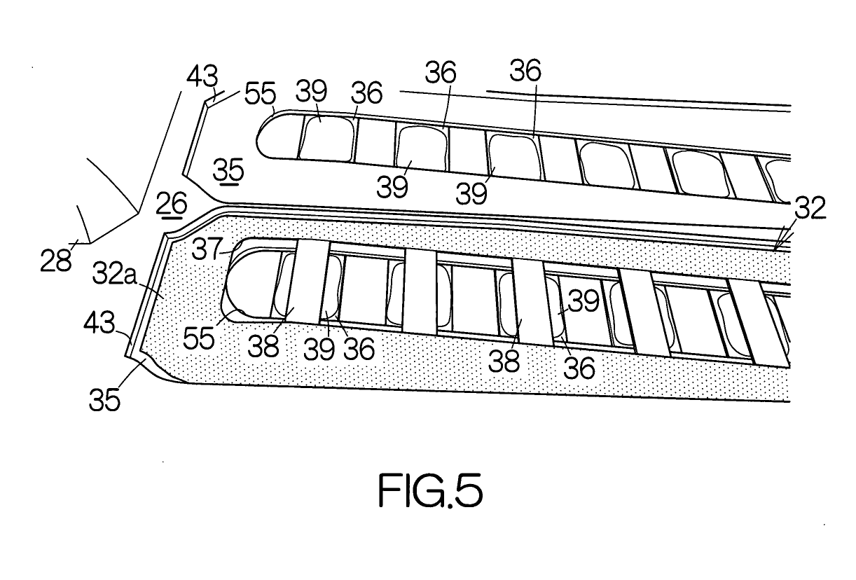

The head suspension assembly 21 is attached to the tip end of the individual carriage arm 19. The second flexible printed wiring board 32 is received in the groove 33. The tail end piece 32a of the second flexible printed wiring board 32 is set on the first flexible printed wiring board 26. The tail end piece 32a is fitted in the depression 35, as shown in FIG. 5. The step 34 serves to position the edge of the tail end piece 32a at a predetermined position. Any part of the edge of the tail endpiece 32a may collide against the wall surface 43. The second terminals 38 of the tail end piece 32a are in this manner positioned on the corresponding first terminals 36 of the first flexible printed wiring board 26.

Here, the extent of the depression 35 depends on the relative positions of the first and second terminals 36, 38 established within the depression 35. Specifically, the second terminals 38 of the tail end piece 32a may be positioned on the corresponding first terminals 36 of the first flexible printed wiring board 26 when the tail end piece 32a is received in the depression 35. Parameters, such as the extent of a gap between the wall surface 43 and the edge of the tail end piece 32a, the distance between the wall surface 43 and the first terminals 36, the extent of the first terminal 36, the distance between the edge of the tail end piece 32a and the second terminals 38, the extent of the second terminal 38, and the like, may be taken into account.

For example, the gap defined between the wall surface 43 and the edge of the tail end piece 32a enables displacement of the tail end piece 32a along the surface of the first flexible printed wiring board 26 within the depression 35. Even if the edge of the tail end piece 32a collides against the wall surface 43 after the displacement of the tail end piece 32a, the second terminals 38 keep remaining on the corresponding first terminals 36. It should be noted that the gap between the wall surface 43 and the edge of the tail end piece 32a is preferably minimized as long as the tail end piece 32a can reliably be received in the depression 35.

The tip end of a bonding tip, not shown, is urged against the second terminal 38 when the second terminals 38 have been positioned right on the corresponding first terminals 36. The bonding tip is previously heated to 400 degrees Celsius, for example. The heat of the bonding tip serves to melt the solder 39. The solder 39 covers over the second terminal 38. The application of heat is then terminated. The solder 39 is cooled down so that the solder 39 gets solidified. The bonding tip is then removed from the solder 39. The solder 39 bonds the second terminal 38 to the first terminal 36 in this manner.

The tail end piece 32a of the second flexible printed wiring board 32 is received in the depression 35 of the first flexible printed wiring board 26 in the hard disk drive 11. The depression 35 is contoured to correspond to the contour of the tail end piece 32a. The wall surface 43 of the step 34 defining the depression 35 thus faces the edge of the tail end piece 32a. The wall surface 43 is allowed to receive the edge of the tail end piece 32a, for example. When the tail end piece 32a is in this manner received in the depression 35, the second terminals 38 can accurately be positioned on the corresponding first terminals 36 in a facilitated manner. The positioning can be achieved in a significantly shorter period.

Furthermore, the height of the step 34 from the surface of the first flexible printed wiring board 26 is set larger than the thickness of the tail end piece 32a. The tail end pieces 32a can be fitted in the depression 35 of the first flexible printed wiring board 26. The tail end piece 32a can thus be held in the depression 35 once the tail end piece 32a is received in the depression 35. The tail end piece 32a can be kept in the depression 35 during the soldering. Working process can be simplified.

In addition, an operator is allowed to simply check with his eyes whether or not the tail end piece 32a is fitted in the depression 35, when he is required to check whether or not the second terminals 38 are aligned with the first terminals 36. The operator is not required to check the relative position between the individual first and second terminals 36, 38 with his eyes. This results in a significant reduction in the period of positioning the second terminals 38 on the corresponding first terminals 36.

A conventional first flexible printed wiring board includes four of the first terminals. A conventional second flexible printed wiring board likewise includes four of the second terminals. The flying head slider 23 according to the embodiment of the present invention additionally includes the heater as described above. Accordingly, the first flexible printed wiring board 26 is required to include additional two of the first terminals 36 for the heater. The second flexible printed wiring board 32 is likewise required to include additional two of the second terminals 38 for the heater. The first and second terminals 36, 38 are closely packed in a smaller area. The second flexible printed wiring board 32 needs be positioned on the first flexible printed wiring board 26 with a still higher accuracy when the second terminals 38 are bonded to the corresponding first terminals 36. The aforementioned method according to the embodiment of the present invention is in particular suitable for the bonding of the second terminals 38 on the corresponding first terminals 36 on the carriage 16.

The depression 35 is defined on the first flexible printed wiring board 26 for the individual tail end piece 32a. The film material 44 serves to insulate the adjacent ones of the tail end pieces 32a from each other. The edge of the individual tail end piece 32a faces the wall surface 43. Even if the solder 29 in a fluid state spreads out of the first terminal 36, the wall surface 43 serves to block the flow of the solder 29. The solder 39 is prevented from reaching the adjacent tail end piece 32a. This results in a reliable avoidance of a short circuit.

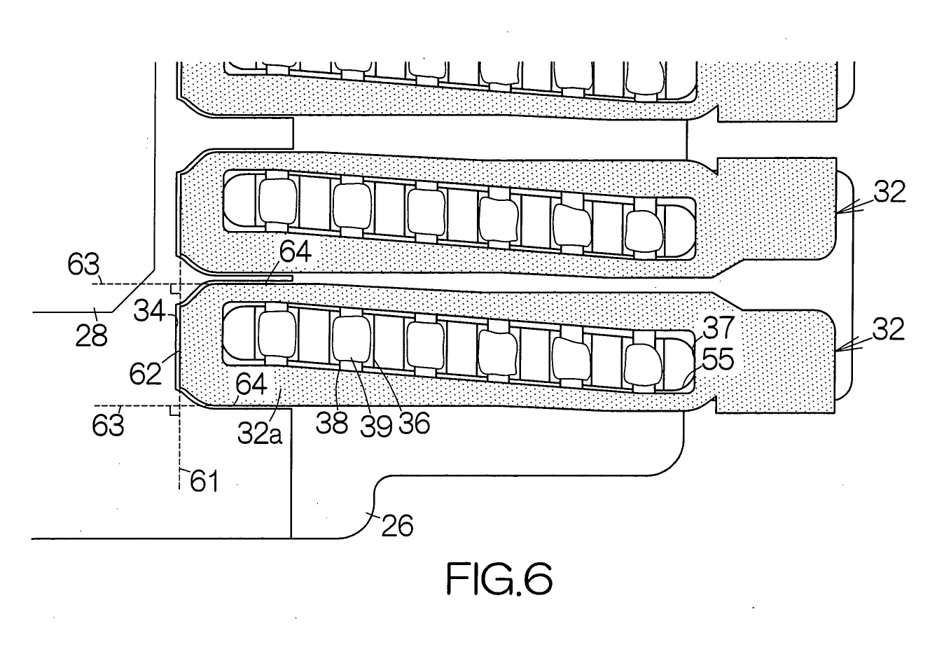

Alternatively, the step 34 may be formed only at a position adjacent to the individual tail end piece 32a, as shown in FIG. 6. Here, the wall surface 43 may face a first edge 62 and a pair of second edges 64. The first edge 62 may extend along a first imaginary reference line 61. The second edges 64 may extend along a pair of parallel second imaginary reference lines 63 intersecting with the first imaginary reference line 61, respectively. The first imaginary reference line 61 may intersect with the individual second imaginary reference line 63 at right angles. The step 34 may be omitted around the tail end piece 32a except the mentioned tip end of the tail end piece 32a.

The film material 44 may be attached to part of the surface of the first flexible printed wiring board 26 for establishment of the step 34. If either of the second edges 64 collides against the wall surface 43 while the first edge 62 collides against the wall surface 43 in the hard disk drive 11, the tail end piece 32a can thus be positioned relative to the first flexible printed wiring board 26 in a facilitated manner. The second terminals 38 can accurately be aligned with the corresponding first terminals 36 in the same manner as described above. The positioning can be achieved in a significantly shorter period.

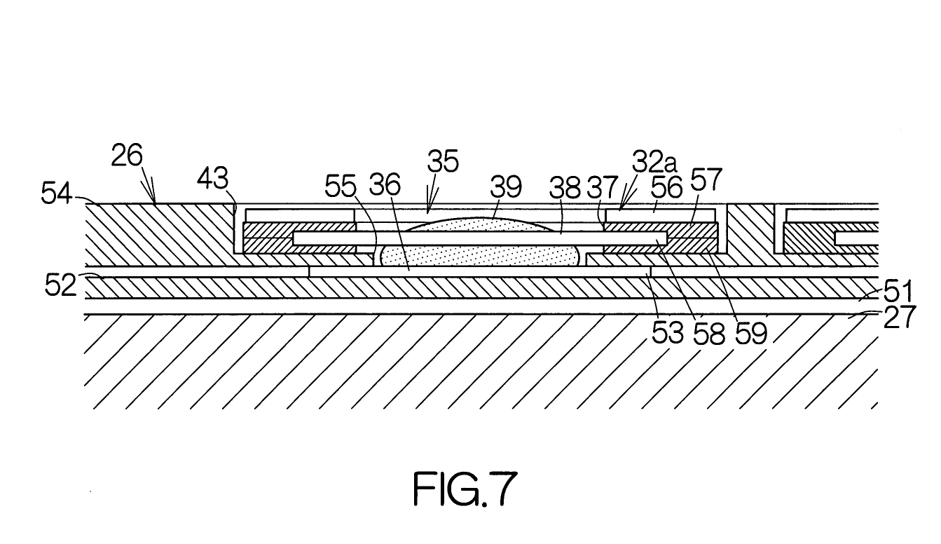

Alternatively, the protecting layer 54 may have a part of an increased thickness, in place of the film material attached to the first flexible printed wiring board 26, as shown in FIG. 7. The depression 34 is formed on the surface of the first flexible printed wiring board 26 so as to define the step 34. The thickness of the protecting layer 54 may partially be changed so as to define the depression 35. A die is urged against a sheet of polyimide resin to form the protecting layer 54 of the type, for example. The first flexible printed wiring board 26 of the type serves to provide the advantages in the same manner as described above.

What is claimed is:

1. A carriage assembly comprising:
a carriage;
a head slider attached to a tip end of the carriage;
a first flexible printed wiring board attached to a supported end of the carriage;
a first terminal exposed on the first flexible printed wiring board;
a second flexible printed wiring board extending from the head slider toward the supported end of the carriage, said second flexible printed wiring board overlaid on the first flexible printed wiring board;
a second terminal exposed on the second flexible printed wiring board, said second terminal bonded to the first terminal; and
a step defining a wall surface facing an edge of the second flexible printed wiring board on the first flexible printed wiring board.

2. The carriage assembly according to claim 1, wherein the step is defined based on a film material attached to a surface of the first flexible printed wiring board.

3. The carriage assembly according to claim 1, wherein the step is defined based on a depression formed in a surface of the first flexible printed wiring board.

4. The carriage assembly according to claim 1, wherein a height of the step is set larger than a thickness of the second flexible printed wiring board.

5. A carriage assembly comprising:
a carriage;
a head slider attached to a tip end of the carriage;
a first flexible printed wiring board attached to a supported end of the carriage;
a first terminal exposed on the first flexible printed wiring board;
a second flexible printed wiring board extending from the head slider toward the supported end of the carriage, said second flexible printed wiring board overlaid on the first flexible printed wiring board;
a second terminal exposed on the second flexible printed wiring board, said second terminal bonded to the first terminal; and
a step defining a wall surface facing first and second edges of the second flexible printed wiring board on the first flexible printed wiring board, said first edge extending along a first imaginary reference line, said second edge extending along a second imaginary reference line intersecting with the first imaginary reference line.

6. A storage medium drive comprising:
a storage medium;
a carriage swinging around a support shaft;
a head slider attached to a tip end of the carriage, said head slider opposed to the storage medium;
a first flexible printed wiring board attached to a supported end of the carriage;
a first terminal exposed on the first flexible printed wiring board;
a second flexible printed wiring board extending from the head slider toward the supported end of the carriage, said second flexible printed wiring board overlaid on the first flexible printed wiring board;
a second terminal exposed on the second flexible printed wiring board, said second terminal bonded to the first terminal; and
a step defining a wall surface facing an edge of the second flexible printed wiring board on the first flexible printed wiring board.

7. The storage medium drive according to claim 6, wherein the step is defined based on a film material attached to a surface of the first flexible printed wiring board.

8. The storage medium drive according to claim 6, wherein the step is defined based on a depression formed in a surface of the first flexible printed wiring board.

9. The storage medium drive according to claim 6, wherein a height of the step is set larger than a thickness of the second flexible printed wiring board.

10. A storage medium drive comprising:
a recording disk;
a carriage swinging around a support shaft;
a head slider attached to a tip end of the carriage;
a first flexible printed wiring board attached to a supported end of the carriage;
a first terminal exposed on the first flexible printed wiring board;
a second flexible printed wiring board extending from the head slider toward the supported end of the carriage, said second flexible printed wiring board overlaid on the first flexible printed wiring board;
a second terminal exposed on the second flexible printed wiring board, said second terminal bonded to the first terminal; and
a step defining a wall surface facing first and second edges of the second flexible printed wiring board on the first flexible printed wiring board, said first edge extending along a first imaginary reference line, said second edge extending along a second imaginary reference line intersecting with the first imaginary reference line.

11. A flexible printed wiring board comprising:
a sheet metal;
an insulating layer formed on the sheet metal;
an electrically-conductive layer formed on the insulating layer;
a protecting layer covering over the insulating layer at a position adjacent to the electrically-conductive layer, said protecting layer having an opening allowing part of the electrically-conductive layer to be exposed; and
a step formed at a position outside the opening to surround at least part of the electrically-conductive layer exposed within the opening.

12. The flexible printed wiring board according to claim 11, wherein the step is defined based on a film material attached to a surface of the protecting layer.

13. The flexible printed wiring board according to claim 11, wherein the step is defined based on a depression formed in a surface of the protecting layer.

14. A method of positioning a terminal, comprising attaching a first flexible printed wiring board on a second flexible printed wiring board, wherein said method comprising arranging an edge of the first flexible printed wiring board along a step defining a wall surface facing the edge of the first flexible printed wiring board on the second flexible printed wiring board, so as to position a first terminal of the first flexible printed wiring board on a second terminal of the second flexible printed wiring board.

15. The method according to claim 14, wherein the step is defined based on a film material attached to a surface of the second flexible printed wiring board.

16. The method according to claim 14, wherein the step is defined based on a depression formed in a surface of the second flexible printed wiring board.

17. The method according to claim 14, wherein a height of the step is set larger than a thickness of the first flexible printed wiring board.
